(19) United States
(12) Patent Application Publication
(10) Pub. No.: US 2008/0144877 A1
(43) Pub. Date: Jun. 19, 2008

(54) Antihelix stabilizer with easy donning action for wearable audio device

(75) Inventors: Soohyun Ham, Santa Cruz, CA (US); Scott A. Dallmeyer, Chicago, IL (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., Santa Cruz, CA (US)

(21) Appl. No.: 10/877,832

(22) Filed: Jul. 1, 2004

(51) Int. Cl. H04R 25/00

(52) U.S. Cl. 381/379; 381/380

(57) ABSTRACT

An antihelix stabilizer with easy donning action for an audio device such as an ear set to provide support and stability when the audio device is worn on the ear is disclosed. The ear set may include a housing, an ear bud extending from the housing and configured to be at least partially positionable in the concha, and a stabilizer extending from the housing. The stabilizer may be resiliently compressible toward the ear bud upon application of force thereon. When donned, the stabilizer is at least partially positioned in a concha of the ear to exert pressure on an antihelix and/or concha wall of the ear which, in cooperation with the ear bud, facilitates in stabilizing the ear set. The stabilizer may be configured in any suitable shape such as a flexible loop, tab, and/or spiral and/or may include an arm extending from the housing and terminating in a flange.

### BACKGROUND OF THE INVENTION

1. Field of the Invention

The present invention relates generally to a supporting element for an audio device wearable on an ear such as an earpiece and headset for use in telecommunications, telephony, and/or multimedia applications. More specifically, an antihelix stabilizer with easy donning action for an audio device such as an ear set to provide support and stability when the audio device is worn on the ear is disclosed.

2. Description of Related Art

Headsets are used in numerous audio applications and are particularly effective for telephone operators, radio operators, aircraft personnel, and for other individuals for whom it is desirable to have hands-free operation of communication and/or other audio systems. Accordingly, a wide variety of conventional headsets are available.

One type of a headset is a monaural headset. Monaural headsets are headsets that have only a single audio receiver for placement near one ear. Such headsets may be very compact and are often implemented with an earloop or earhook that is configured to fit around the ear to secure the receiver in place. Another example of a monaural headset is an earpiece containing a speaker and optionally a microphone. Such an earpiece is often wireless. The earpiece can be smaller, lighter, more comfortable, and more discrete.

However, most audio products intended to be worn on the ear tend to be unstable when worn and can be cumbersome and uncomfortable to use. In addition, many are difficult to don because of unintuitive design.

### SUMMARY OF THE INVENTION

An antihelix stabilizer with easy donning action for an audio device such as an ear set to provide support and stability when the audio device is worn on the ear is disclosed. It should be appreciated that the present invention can be implemented in numerous ways, including as a process, an apparatus, a system, a device, or a method. Several inventive embodiments of the present invention are described below.

The ear set may include a housing, an ear bud extending from the housing and configured to be at least partially positionable in the concha of the user's ear, and a stabilizer extending from the housing. The stabilizer may be resiliently compressible toward the ear bud upon application of force thereon. When the ear set is donned, the stabilizer is at least partially positioned in a concha of the ear to exert pressure on an antihelix and/or concha wall of the user's ear which, in cooperation with the ear bud, facilitates in stabilizing the ear set in the ear. The antihelix stabilizer may be configured in any suitable shape such as a flexible loop, tab, and/or spiral and/or may include an arm extending from the housing and terminating in a flange that extends generally away from the ear bud.

The extension arm may be approximately U-shaped, C-shaped, or L-shaped and extend between the housing and the flange generally in a direction of the ear bud. An ear bud post may be disposed between the ear set housing and the ear bud and may optionally facilitate in positioning the ear bud relative to the housing. The stabilizer extends from the housing generally in a direction of the ear bud post, i.e., toward the ear when donned. The stabilizer may define at least one rib and/or indentation on a surface thereof to facilitate compression of the stabilizer. In addition, the housing may include control and/or signals such as LED's disposed thereon.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 shows an illustrative ear set employing an antihelix stabilizer donned on an ear.

FIGS. 2 and 3 show the ear set employing the antihelix stabilizer of FIG. 1 in more detail.

FIG. 4 is a schematic view of an external ear.

FIG. 5 is a schematic view illustrating the positioning of the ear set of FIG. 1 in the external ear shown in a cut-away view.

FIGS. 6 and 7 illustrate a perspective and a side view, respectively, of an ear set employing an alternatively configured antihelix stabilizer.

### DESCRIPTION OF SPECIFIC EMBODIMENTS

An antihelix stabilizer with easy donning action for an audio device such as an ear set to provide support and stability when the audio device is worn on the ear is disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

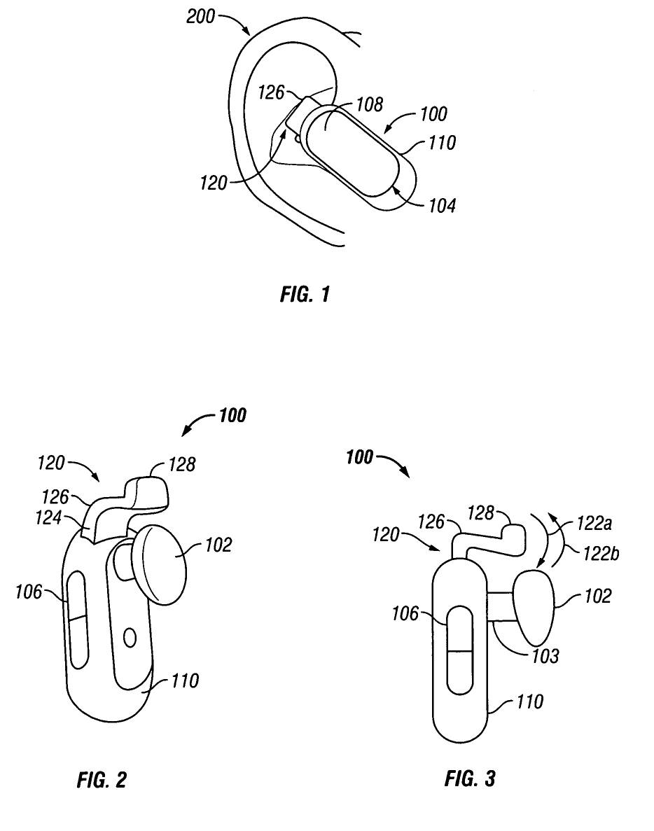

FIG. 1 shows an illustrative ear assembly, ear piece, or ear set 100 employing an antihelix stabilizer 120 donned on an ear 200 and FIGS. 2 and 3 show the ear set 100 employing the antihelix stabilizer 120 of FIG. 1 in more detail. The ear set 100 may be part of wired or wireless communication or other audio system that includes a base audio unit in communication with the ear set 100. It is noted that the ear set 100 may be employed in a variety of suitable audio systems or devices including communications systems. The ear set 100 generally includes a speaker such as one contained in an ear bud 102 or in the housing 110 and an optional microphone 104 supported by a body or housing 110. A post 103 may extend between the ear bud 102 and the housing 110 to, for example, provide a distance therebetween. The length of the post 103 may be adjustable. The ear bud 102 and/or the post 103 may be pivotable relative to the housing 110 to enable adjustment of the angle of the ear bud 102 relative to the housing 110. In addition, the position of the ear bud 102 relative to the housing 110 may be adjustable, e.g., the ear bud 102 may be slidable along a length of the housing 110. In the example shown in FIGS. 1-3, the ear bud 102 extends from the housing 110 to facilitate placement or insertion of the ear bud 102 at least partially in the concha of the ear 200 and optionally at least partially within or at the entrance to an ear canal of the ear 200. The ear set 100 may provide various controls 106 such as controls for the volume, power, device connect/disconnect, and/or various other controls. In addition, the ear set 100 may also provide various signals such as one or more light emitting diodes (LED's) 108 to signal power on/off and/or device connect/disconnect state or status, for example. The one or more LED's 108 may emit the same or different colored light and/or may be emit light continuously and/or intermittently in various on/off patterns, depending on the particular state that is signaled, for example. The controls 106 and/or signals 108 may be provided in various locations on the housing 110 or other parts of the ear set 100 in addition to the exemplary locations shown in FIGS. 1-3. The ear set 100 may also provide various other features as is known in the art.

When the ear set 100 is donned on the user's ear, the ear set 100 is retained by the user's ear and more specifically by the antihelix stabilizer 120 and the concha of the ear 200 and allows for hands free use of the communication or audio system. The ear set 100 may further be retained in part by the ear canal if, for example, the ear bud 102 is configured to be at least partially positioned in the ear canal. Because the ear set 100 is supported by the user's ear 200, the size and arrangement of the ear set 100 results in a smaller and thus more discrete and more unobtrusive device.

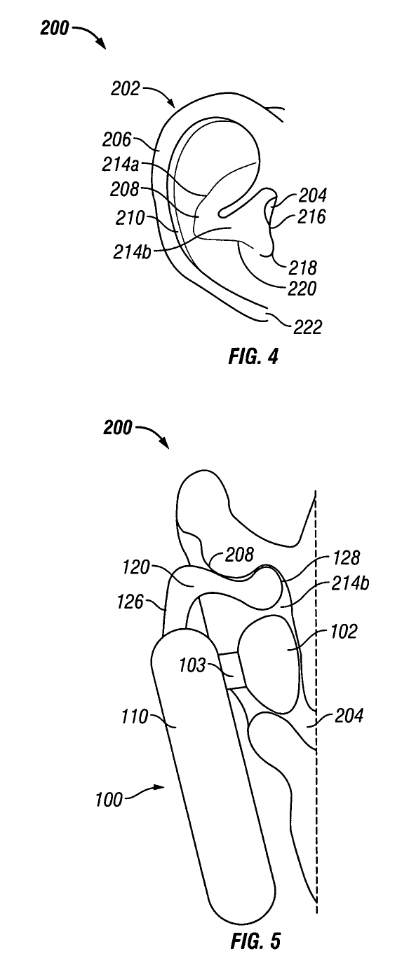

Prior to describing the antihelix stabilizer 120 of the ear set 100 in more detail, a brief overview of the anatomical structure of the human ear is presented with reference to FIG. 4. Specifically, FIG. 4 is a schematic view of an external ear 200. The human ear is generally divided into three parts, the external ear 200, the middle ear (or tympanum cavity or ear drum) and the internal ear (or labyrinth). The middle ear and the internal ear are not shown nor described in further detail herein. The external ear 200 includes an expanded portion or pinna or auricula 202 and an ear canal or external acoustic meatus 204. The pinna 202 projects from the side of the head to collect vibrations of the air by which sound is produced while the ear canal 204 leads inward from the bottom of the pinna 202 and conducts the vibrations to the ear drum in the middle ear.

Typically, the pinna 202 has a prominent curved rim or helix 206 and another curved prominence or antihelix 208 generally parallel with and in front of the helix 206. The scapha 210 is a narrow-curved depression between the helix 206 and the antihelix 208. The antihelix 208 describes a curve around a deep, capacious cavity, the concha 214. The concha 214 is partially divided into two parts by the commencement of the helix in which the upper part of the concha 214 is the cymba 214a while the lower part is the cavum 214b. In front of the concha 214 and projecting backward over the ear canal 204 is a small pointed eminence or the tragus 216. Opposite and separated from the tragus 216 by the intertragic notch 218 is a small tubercle or the antitragus 220. Below the antitragus 220 is the lobule 222. The ear canal 204 extends from a bottom of the concha 214 to the ear drum of the middle ear (not shown).

Referring again to FIGS. 1-3, the antihelix stabilizer 120 is preferably integral with and extends from the housing 110. The antihelix stabilizer 120 is resiliently flexible in directions as shown by arrows 122a, 122b in FIG. 3. More specifically, the antihelix stabilizer 120 can be manually deflected or pressed by a user in a direction 122a, i.e., decreasing the distance between the stabilizer 120 and the ear bud 102, during positioning and donning of the ear set 100 on the user's ear 200. Upon release of the antihelix stabilizer 120, the stabilizer 120 generally returns to its initial position or distance relative to the ear bud 102 in a direction 122b.

The antihelix stabilizer 120 with easy donning action serves as a supporting element to the wearable audio device or ear set 100. To don, the user presses the antihelix stabilizer 120 inward or downward in a direction 122a, i.e., toward the ear bud 102, while holding the ear set 100. The user may then place the ear bud 102 at least partially into the concha and optionally partially into the ear canal, and positions the stabilizer 120 in the concha of the user's ear 200. Upon release of the stabilizer 120 in the concha of the user's ear, the stabilizer 120 returns or expands in a direction 122b away from the ear bud 102.

FIG. 5 is a schematic partially cut-away view illustrating the positioning of the ear set 100 donned in/on the external ear 200. As shown, after the ear bud 102 and the antihelix stabilizer 120 of the ear set 100 are positioned in/on the ear and the antihelix stabilizer 120 is released, the antihelix stabilizer 120 returns or expands (in a direction 122b away from the ear bud 102) within the concha to the point at which the antihelix stabilizer 120 engages the user's antihelix and/or the cavum. More specifically, the antihelix stabilizer 120 returns until a flange of the stabilizer 120 engages a concha wall and/or an extension arm 126 of the stabilizer 120 engages the antihelix of the user's ear. The antihelix stabilizer 120, in cooperation with the ear bud 102, exerts gentle tension or pressure in the concha and/or against the antihelix to stabilize the ear set 100 on the user's ear 200. The compression of the antihelix stabilizer 120 allows easy donning of the ear set 100 for the user. In addition, because the antihelix stabilizer 120 returns in the direction 122b until engagement with the user's antihelix and/or concha wall, the antihelix stabilizer 120 is self-adjusting to ensure a secure fit of the ear set 100 when worn. Thus, the antihelix stabilizer 120 provides stability, ease of operation and ease of donning.

The antihelix stabilizer 120 is preferably integral with the housing of the ear set 100 to prevent the stabilizer 120 from being separated from the housing 110 and becoming misplaced or lost. The antihelix stabilizer 120 may be configured in any suitable configuration such as a flexible tab, flexible loop, spiral, and the like. In the example shown in FIGS. 1-3, the antihelix stabilizer 120 is configured as a flexible tab in which the antihelix stabilizer 120 includes the extension arm 126, generally U-, L- or C-shaped, extending from and preferably integrated with the housing 110 at one end and terminating at the opposite end in the flange 128 extending away from the ear bud 102 to provide the antihelix engagement mechanism. The extension arm 126 may define indentations or ribs 124 on a surface that faces, i.e., adjacent to or opposes, the user's ear 200 to facilitate bending or compressing of the antihelix stabilizer 120 toward the ear bud 102.

Although the housing 110 is generally shown to be a rounded rectilinear shape, the housing 110 may be in any other suitable configuration. The housing 110 may be made from any suitable material such as plastic, metal, rubber, gel-like material, and the like. The ear bud 102 may preferably be made of a compressible material for comfort such as rubber, a gel-like material, and the like to allow compression for insertion into and frictional engagement with the internal walls of the user's concha and/or ear canal. Alternatively, the ear bud 102 may be made of a non-compressible material such as plastic and the like. The antihelix stabilizer 120 or portions thereof may be made of a resiliently pliable material such as rubber, a gel-like material, a sound absorbing or sound proofing material, and/or include a sound insulating material such as foam. Alternatively, the antihelix stabilizer 120 or portions thereof may be made of a rigid material such as plastic and be provided with a flexing mechanism such as a spring hinge or the like. The range of motion of the antihelix stabilizer 120 and the distance between the stabilizer 120 and the ear bud 102 may be configured so that the ear set 100 is suitable for use by most if not all potential users of the ear set 100. Alternatively, ear sets with varying sizes or ranges of motion of the antihelix stabilizer 120 may be provided for users with different sized ears.

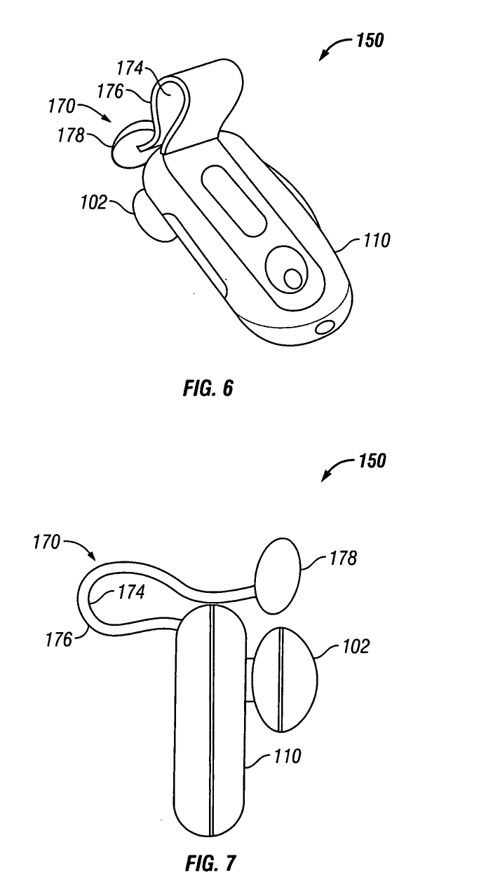

An alternative ear set 150 employing an antihelix stabilizer 170 configured with a flexing or flexible loop 176 is shown in the perspective and side views, respectively, of FIGS. 6 and 7. As shown, the flexible loop 176 serves as an extension arm that is approximately U-shaped and extends from and is preferably integrated with the housing 110 at one end and terminating at the opposite end in a flange 178 extending away from the ear bud 102 to provide the an antihelix engagement mechanism. The extension arm 176 may also define ribs or indentations 174 on an interior surface thereof, i.e., on a surface that faces (i.e., opposes or adjacent to) the user's ear to facilitate bending or compressing of the antihelix stabilizer 170 toward the ear bud 102. As is evident, various other configurations of the antihelix stabilizer may be employed to facilitate in stabilizing the ear set in the ear.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. An ear set wearable on an ear of a user, comprising:
an ear set housing;
an ear bud extending from the ear set housing and configured to be at least partially positionable in a concha of the ear of the user; and
a stabilizer extending from the ear set housing, the stabilizer being compressible toward the ear bud upon application of an external force thereon and resiliently expansible away from the ear bud upon release of the external force, the stabilizer being further configured to exert pressure on at least one of an antihelix and a concha wall of the user's ear when generally disposed in a concha of the ear to, in cooperation with the ear bud, stabilize the ear set relative to the ear of the user.

2. The ear set of claim 1, wherein the stabilizer includes an extension arm and a flange, the extension arm extending from the ear set housing at one end and terminating at the opposite end in the flange and the flange extending from the extension arm in a direction generally away from the ear bud.

3. The ear set of claim 2, wherein, when donned, the extension arm is configured to engage the antihelix of the user's ear and the flange is configured to engage the concha wall of the user's ear.

4. The ear set of claim 2, wherein the extension arm is one of approximately U-shaped, C-shaped, and L-shaped.

5. The ear set of claim 2, wherein the extension arm extends between the housing and the flange generally in a direction toward the ear bud.

6. The ear set of claim 1, further comprising an ear bud post extending between the ear set housing and the ear bud.

7. The ear set of claim 1, wherein the stabilizer defines at least one rib on a surface thereof adjacent the ear bud to facilitate compression of the stabilizer.

8. The ear set of claim 1, wherein the stabilizer is selected from the group consisting of a flexible loop, a flexible tab, and a spiral.

9. The ear set of claim 1, wherein the stabilizer is integral with the ear set housing.

10. The ear set of claim 1, wherein the stabilizer includes a spring hinge to enable the stabilizer to rotate relative to the ear set housing.

11. An ear set wearable on an ear of a user, comprising:
a body;
an ear bud extending in a first direction from the body and configured to be at least partially positioned in a concha of the ear of the user; and
a resiliently compressible member extending from the body generally in the first direction, the member being resiliently compressible toward the ear bud upon application of a force thereon, the member being further configured to exert pressure on at least one of an antihelix and a concha wall of the user's ear when generally disposed in a concha of the ear, the combination of the pressure exerted by the member and the ear bud being at least partially positioned in the concha facilitates in stabilizing the ear set on the ear of the user.

12. The ear set of claim 11, wherein the resiliently compressible member includes an extension arm and a flange, the extension arm extending from the body at one end and terminating at the opposite end in the flange, and the flange extending from the extension arm in a direction generally orthogonal to the first direction away from the ear bud.

13. The ear set of claim 12, wherein, when donned, the extension arm is configured to engage the antihelix of the user's ear and the flange is configured to engage the concha wall of the user's ear.

14. The ear set of claim 12, wherein the extension arm is one of approximately U-shaped, C-shaped, and L-shaped.

15. The ear set of claim 12, wherein the extension arm extends between the body and the flange generally in the first direction.

16. The ear set of claim 11, further comprising an ear bud post generally extending in the first direction between the body and the ear bud.

17. The ear set of claim 11, wherein the resiliently compressible member defines at least one rib on a surface thereof adjacent the ear bud to facilitate compression of the resiliently compressible member.

18. The ear set of claim 11, wherein the resiliently compressible member is selected from the group consisting of a flexible loop, a flexible tab, and a spiral.

19. The ear set of claim 11, wherein the resiliently compressible member is integral with the body.

20. The ear set of claim 11, wherein the resiliently compressible member includes a spring hinge to enable the resiliently compressible member to rotate relative to the body.
